(19) United States
(12) Patent Application Publication
(10) Pub. No.: US 2007/0289965 A1
(43) Pub. Date: Dec. 20, 2007

(54) PAN LINER

(76) Inventor: Lawrence Greenfield, West Hartford, CT (US)

Correspondence Address: CANTOR COLBURN, LLP, 55 GRIFFIN ROAD SOUTH, BLOOMFIELD, CT, 06002, US

(21) Appl. No.: 11/764,321

(22) Filed: Jun. 18, 2007

Related U.S. Application Data
(63) Continuation-in-part of application No. 10/000,948, filed on Oct. 24, 2001.
(60) Provisional application No. 60/242,972, filed on Oct. 24, 2000.

(51) Int. Cl. A21B 3/13

(52) U.S. Cl. 220/23.9

(57) ABSTRACT

A pan liner is provided, the pan liner including a first liner side panel having a first upper edge; a second liner side panel having a second upper edge; and at least one seam joining the first and second side panels, the first side panel, second side panel and at least one seam forming an interior region having an opening along the first and second upper edges, and wherein the at least one seam defines a continuously curved path along at least a lower portion of the interior region.

### CROSS REFERENCE TO RELATED APPLICATIONS

The present application claims the priority of co-pending U.S. patent Ser. No. 10/000,948, filed Oct. 24, 2001, which claimed priority to U.S. Provisional Application Ser. No. 60/242,972, filed Oct. 24, 2000, the entire contents of each of which are specifically incorporated herein by reference.

### FIELD OF THE INVENTION

The invention relates to a liner for a pan having special seam geometies.

### BACKGROUND OF THE INVENTION

The food preparation industry relies heavily on non-disposable cookware for both hot and cold food preparation. Such cookware is typically used, re-used, scrubbed and washed several times during a workday. In fact, many restaurants maintain a staff of employees whose primary responsibilities are scrubbing and washing such cookware. Many restaurants consider the expenses associated with hiring and maintaining the staff of employees responsible for scrubbing, with purchase of cleaning supplies and hot water, with maintaining a scrubbing station within the restaurant, and with waste caused by either scorching of the food, lack of convenient storage or food which cannot easily be removed from the edges of the cookware to be necessary and unavoidable expenses.

What is needed in the art is a low cost solution to the problems associated with cleaning soiled cookware as they are laid out above.

### BRIEF SUMMARY OF THE INVENTION

The present contoured pan liner overcomes and alleviates the above and other problems in the art by providing a first liner side panel having a first upper edge; a second liner side panel having a second upper edge; and at least one seam joining the first and second side panels, the first side panel, second side panel and at least one seam forming an interior region having an opening along the first and second upper edges, and wherein at least a portion of the at least one seam defines a continuously curved path along an interior region.

In an exemplary embodiment, the liner is generally contoured to fit within an article of cookware. In another exemplary embodiment, the liner is substantially contoured to the shape of an article of cookware. In another exemplary embodiment, at least two seams provided along an interior region of the liner generally trace continuously curved paths along the interior region.

In another exemplary embodiment, the liner has a continuously curved seam along the interior region and is not specifically contoured to the shape of an article of cookware. In such case, a single liner type may be used in a plurality of differently contoured pans or other cookware articles.

Further, in another exemplary embodiment, the liner comprises a non-heat sealable temperature resistant polyester as an outer laminate layer and a heat sealable polyolefin, such as a polyethylene or polypropylene, as an inner laminate layer.

### BRIEF DESCRIPTION OF THE DRAWINGS

Referring now to the drawings wherein like elements are numbered alike in the several FIGURES:

FIG. 1 is a perspective view of an exemplary pan liner;

FIG. 2 is a perspective view of an exemplary pan liner in position within an exemplary pan;

FIG. 3 is a perspective view of another exemplary pan liner;

FIG. 4 is a perspective view of another exemplary pan liner;

FIG. 5 is a plan view of an exemplary liner seam geometry; and

FIG. 6 is a plan view of another exemplary liner seam geometry.

### DETAILED DESCRIPTION OF THE INVENTION

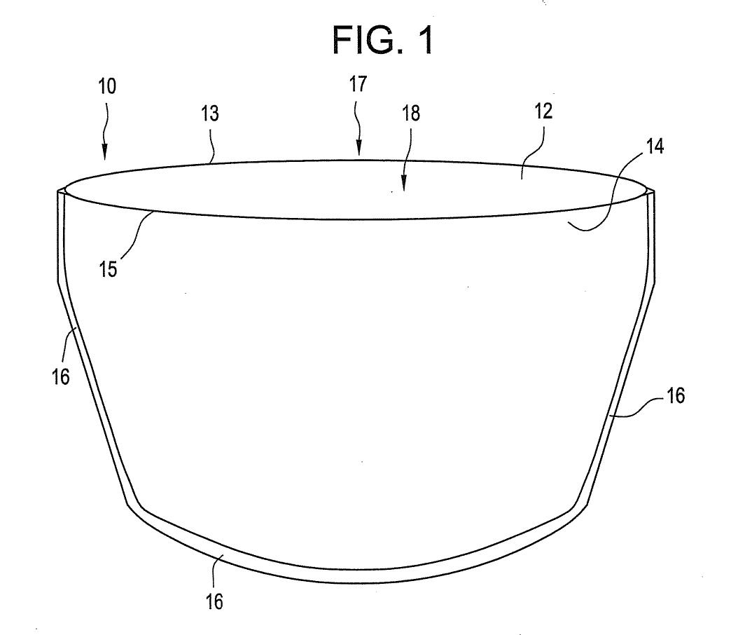

Referring to FIG. 1, an exemplary pan liner is shown generally at 10. The exemplary pan liner comprises first and second side panels 12, 14 sealed along a seam 16. The panels 12, 14 are illustrated as being of similar size and shape, such that the pan liner is generally symmetric with respect to the seam 16. An interior region 18 is defined by the first and second side panels 12, 14 and the seam 16. The upper edges 13, 15 of the first and second panels 12, 14 define an opening 17 in the liner. In the illustrated embodiment, the sealed contoured seam 16 extends in a continuous arcuate path around the interior region 18 of panels 12, 14. The seals may be formed by any method known in the art, but are preferably heat-sealed.

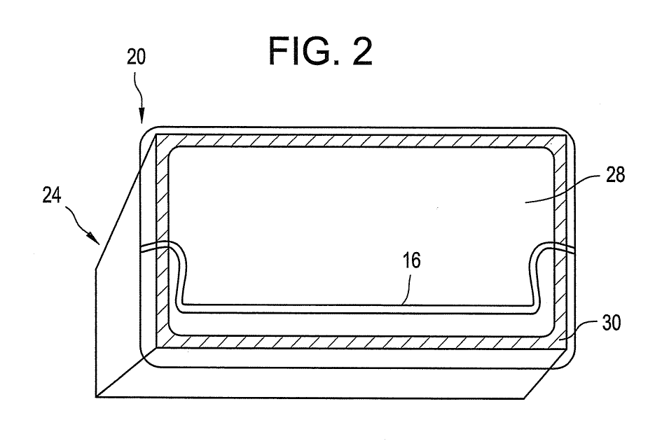

Referring now to FIG. 2, an exemplary pan liner is generally shown at 20 disposed within a pan, shown generally at 24. The contoured seam 16, extends from within the pan 24, up the inner sides 26 (not shown), 28 of the pan 24, and over the top edge 30 of the pan 34. Thus, the upper edges 13, 15 of the first and second side panels 12, 14 are illustrated as configured to engage the top of the pan 34.

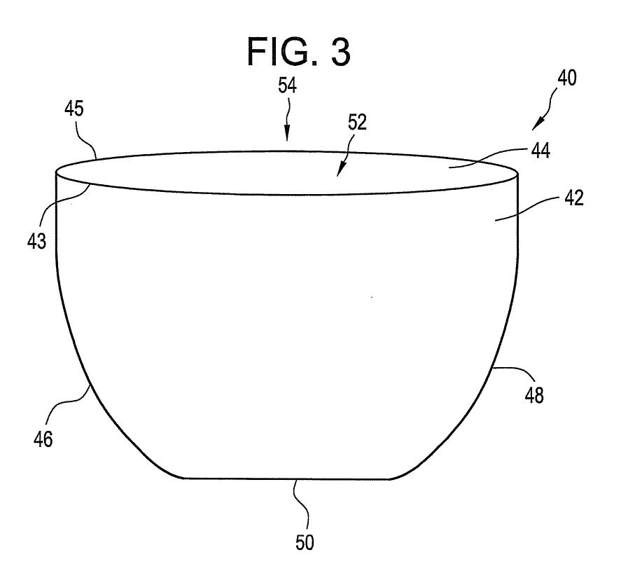

With reference to FIG. 3, another exemplary embodiment of a pan liner is illustrated generally at 40. In the illustrated embodiment, first and second panels 42, 44 are sealed along first and second seams 46, 48 and along a lower fold line 50. The first and second panels 42, 44, first and second seams 46, 48 and lower fold line 50 define an interior region, shown generally at 52. First and second upper edges 43, 45 of first and second panels 42, 44 define an opening, shown generally at 54.

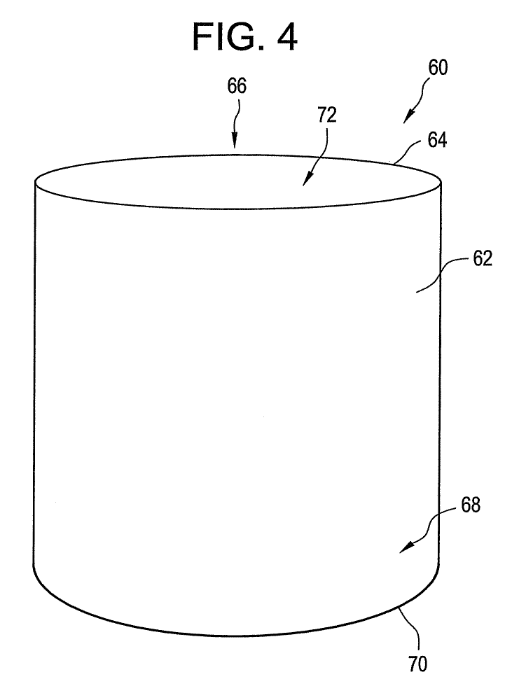

With reference to FIG. 4, another exemplary embodiment of a pan liner is illustrated generally at 60. The exemplary pan liner comprises a tube 62 of liner material having an upper edge 64 defining an opening, shown generally at 66. The tube is sealed at a lower end portion 68 by a seam 70. The seam 70 and the tube 62 define an interior region, shown generally at 72. The seam 70 traces a generally arcuate path along a lower portion of the interior space 72.

In one exemplary embodiment, the materials employed for construction of the pan liner include plastic laminates. That is, the panels comprise at least two layers of plastic in which may be joined or laminated by conventional methods. In one embodiment, the outer layer is a non-heat sealable material capable of resisting sustained temperatures of up to about 200 degrees Fahrenheit, such as those temperatures that are used for reheating of foods and service presentation of foods, rather than those temperatures required for cooking of foods. In another exemplary embodiment, the outer layer is a non-heat sealable material capable of resisting sustained temperatures of up to and above 400 degrees Fahrenheit, such as the temperatures that may typically be encountered in the cooling of foods. In another exemplary embodiment, the outer layer is a non-heat sealable, low to high temperature, heat resistant material, such as a polyester material. In another exemplary embodiment, the outer laminate layer is a material similar to those types of heat resistant materials sold under the trade name Mylar.

In another embodiment, the inner layer is heat sealable material that will not degrade in low to high temperature environments and that is safe for food contact. The heat sealable materials of the inner layer may provide an airtight and water tight barrier along the seams of the pan liner. Such inner layer also need not directly contact the heated source, and as such it may be a material having a lower temperature resistance (and thus, lower cost) than the outer layer. In one embodiment, the inner layer is a heat-sealable polyolefin material. In another embodiment, the inner layer is a polypropylene or polyethylene material.

In another embodiment, the material is a polyethylene (PET) and low density polyethylene laminate (LDPE). In another embodiment, the construction is approximately 0.00048 PET and 0.001 LDPE. In another embodiment, the material is PET and cast polypropylene (CPP). In another embodiment, the construction is approximately 0.00048 PET and 0.001 CPP.

The liner, when expanded, defines an interior region, which provides a depth sufficient to fit into the bottom of a pan. The laminate construction and continuously curved geometry provide the ability to neatly hold any remaining material when the liner is removed from the pan. In one embodiment, the dimensions of the interior region are such that when the pan liner is placed within a pan, the interior region is substantially contoured to the pan such that free space between the liner and the pan is minimized and such that bunching of the material (where the material is too large for the pan) is minimized.

In another exemplary embodiment, the liner has a continuously curved seam along the interior region and is not specifically contoured to the shape of an article of cookware. In such case, a single liner type may be used in a plurality of differently contoured pans or other cookware articles.

The illustrated seaming configurations illustrated by the exemplary embodiment as shown in FIGS. 1-4, wherein at least one seam is provided and wherein the at least one seam defines an arcuate path along the interior region, also plays an important role in minimizing waste by eliminating troublesome corners along the seams.

FIG. 1 illustrates an exemplary liner independently from the pan. As can be seen, the contoured seam 16 traces an arcuate path along a lower portion of the interior space 18. The curved seam path extends at least along a lower portion of the interior space and may extend continuously from the lower portion to either or both of the seam edges at the opening of the liner. Thus, food cannot accrue in areas inaccessible to a spoon or other instrument. This exemplary liner not only eliminates waste by virtue of the interior space 18 geometry, but also provides for easy food removal from the liner whether the liner is fully open or partially collapsed.

Producing an exemplary liner with a continuously curved seam further provides for a smooth sweep line when a spoon or other utensil is used to remove food from the liner (either fully open or partially collapsed).

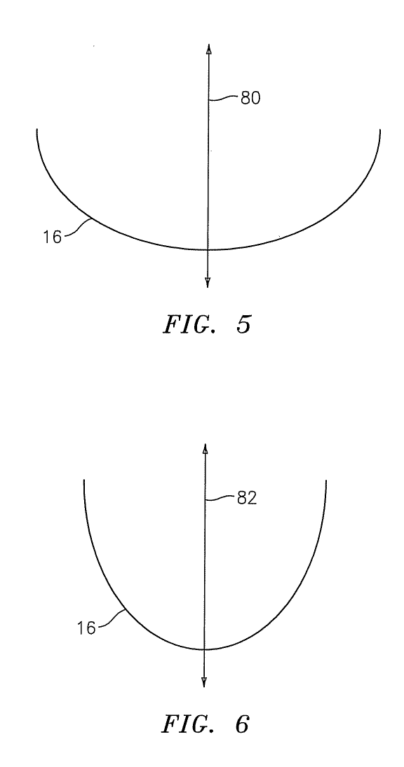

Referring to FIG. 5, an exemplary geometry of a continuously curved seam 16 is illustrated. This particular exemplary seam geometry comprises a portion of an ellipse symmetric around the minor axis of the ellipse. FIG. 6 similarly illustrates an exemplary geometry of a continuously curved seam 16, wherein the curved seam comprises a portion of an ellipse symmetric around the major axis 82 of the ellipse.

It should be recognized that an ellipse is simply one non-limiting example of a continuously curved seam geometry. Also, the continuously curved seam need not be symmetric about an axis.

Lining such cookware advantageously provides a sanitary cooling and/or serving surface. Lining pans is an efficient means of food service as it removes the need for washing pans, eliminating the cost of washing and the time a pan is made unavailable while it is being washed. Pans can be immediately re-lined and reused. The present pan liner also provides an advantageous seaming configuration, including an arcuate seam path along the interior region, for facilitating food removal whether the liner is expanded or partially collapsed. The present pan liner also advantageously provides a laminate material tailored to reduce costs and to provide exterior heat resistance coupled with interior sealing and food compatibility at elevated temperatures.

Although the invention has been shown and described with respect to exemplary embodiments thereof, it should be understood by those skilled in the art that various changes, omissions, and additions may be made thereto, without departing from the spirit and scope of the invention.

What is claimed is:

1. A pan liner, comprising:
a first pan liner side panel having a first upper edge;
a second pan liner side panel having a second upper edge; and
at least one seam joining the first and second side panels, the first side panel, second side panel and at least one seam forming an interior region having an opening along the first and second upper edges, and wherein the at least one seam defines a continuously curved path along at least a lower portion of the interior region.

2. The pan liner in accordance with claim 1, wherein the continuously curved path extends to an upper edge of said first and second pan liner sides joined by said at least one seam.

3. The pan liner in accordance with claim 2, wherein the seam path is continuously curved from a first upper edge of said first and second pan liner sides joined by said at least one seam and along the length of the interior region to a second upper edge of said first and second pan liner sides joined by said at least one seam.

4. The pan liner in accordance with claim 3, wherein the liner is symmetric with respect to the at least one seam.

5. The pan liner in accordance with claim 1, wherein the at least one seam defines an elliptical path.

6. The pan liner in accordance with claim 5, wherein the at least one seam defines an elliptical path from a first upper edge of said first and second pan liner sides joined by said at least one seam and along the length of the interior region to a second upper edge of said first and second pan liner sides joined by said at least one seam.

7. The pan liner in accordance with claim 3, wherein the panels comprise a non-heat sealable temperature resistant polyester outer laminate layer and a heat sealable polyolefin inner laminate layer.

8. The pan liner in accordance with claim 7, wherein the inner laminate layer is a polyethylene or polypropylene material.
